(19) United States
(12) Patent Application Publication
(10) Pub. No.: US 2015/0233604 A1
(43) Pub. Date: Aug. 20, 2015

(54) Induction-heating Device of a Water Heater and Water Heater Provided with such a Device

(71) Applicant: WINSLIM, Luxembourg (LU)

(72) Inventor: Jean-Yves Gaspard, Gleize (FR)

(21) Appl. No.: 14/421,733

(22) PCT Filed: Aug. 5, 2013
(86) PCT No.: PCT/EP2013/066427

§ 371 Date: Feb. 13, 2015

(30) Foreign Application Priority Data
Aug. 13, 2012 (FR) 12 57790

(51) Int. Cl. F24H 7/00; H05B 6/10

(52) U.S. Cl. CPC F24H 7/002; H05B 6/108; F24H 2250/08

(57) ABSTRACT

The present invention relates to an induction-heating device of a water heater and a water heater provided with such a device. The water heater comprises a power generator and an inductive module formed by the at least one inductor and the at least one load, the at least one inductor being configured such as to generate an induced current in the at least one load, the inductor and the at least one load being submerged in the volume of water to be heated. The invention can be used in the field of household or professional water heaters.

### FIELD OF THE INVENTION

The present invention relates to an induction-heating device of a water heater and a water heater provided with such a device and thus relates to the field of water-heating appliances also referred to as water heaters, the heating thereof taking place by induction.

### BACKGROUND OF THE INVENTION

Water heaters are devices which make it possible to heat water for various household or industrial needs. Water heater is understood to refer to a water-accumulator appliance which has at least one vessel that acts as a heating body for storing hot water, also often referred to as tank. The water heater according to the invention is also understood to be an instant-heating appliance. The vessel is the area in which the water is heated. The vessel is often referred to as heating body or tank. The capacity of such a vessel is larger or smaller according to the needs for which the accumulator appliances are intended, for example by being connected with one or more washbasin taps, a shower and/or a bath, etc.

The heating energy sources of a water heater are mainly gas, fuel oil or electricity. The present invention relates to electric water heaters.

In a known manner, an electric water heater has a heating element submerged in the vessel acting as a heating body, making it possible to heat the water contained therein. Said heating element is often an element, generally referred to as a “shielded element”, of modest size and provided, due to the technology thereof, with an especially small exchange surface with the water. Therefore, the power of the shielded element is not very high in order to prevent the shielded element from causing local boiling and to prevent the shielded element from being damaged when furred and no longer correctly exchanging energy with the water to be heated.

Limescale is found in suspension in water practically everywhere, and when the water contained in the vessel acting as a heating body is heated, the molecular agitation causes the precipitation of the limescale or the furring of the shielded element and, in general, the hot portions including the pipes of the water heater. Furring is a major problem for water heaters since, according to the properties of the water, after successive heating operations the heating element becomes covered with scale. This has the dual effect of reducing the heat exchange with the water and of reducing the service life of the heating element, which overheat and eventually destroys itself. The deposited scale reduces the transfer of heat to the water, and the heating element overheats. If the heating element is excessively furred, the heat transfer to the water becomes difficult and the water is not correctly heated because either the thermostat halts the heating before the set temperature for heating the water is reached such as to protect the heating element, which is at risk of being damaged, or the thermostat does not detect the overheating of the heating element, which continues to heat and is then damaged.

In order to prevent such furring, heating elements which are inserted in sheaths are available. Said heating elements are referred to as steatite heating elements, from the name of the insulator which supports said resistive element. Said heating elements are therefore no longer in contact with the water and thus do not become furred. However, this merely transfers the problem to the sheath, advantageously made of steel, which is submerged in the water and indirectly becomes the element heating the water, thus becoming furred. The use of such a sheath for a heating element thus does not solve the problem of the degradation of energy transfer.

Moreover, the heat transfer between the heating element and the sheath is not very good, and such a heating element with a sheath is therefore not satisfactory.

It follows that water heaters with at least one heating element in the form of a heating resistance do not offer very satisfactory performance. Moreover, said heating elements are only regulated by a thermostat and operate in on-off mode, which is not compatible with new electricity generation technologies or home-automation installations and the combination of same with such installations is inadequate.

Said incompatibility is particularly disadvantageous given the advent of green energy and the increasingly widespread use of smart energy-management systems.

The problem with green energies such as wind turbines or photovoltaic cells is the difficulty in matching the generation of electricity with the use thereof. A wind turbine will generate when the weather is windy, while a photovoltaic cell will generate when the weather is sunny. It is impossible to match demand to generation under these conditions. The solution consists of storing the energy, for example in the form of electricity in batteries, or in the form of hot water in water heaters.

Water heaters with conventional heating elements are not well-suited to this requirement. Indeed, the heating element is actuated in on-off mode, in other words it is either switched off or operating at full power.

Document EP-A2-2420755 describes a device for boiling water. Said device comprises a circuit for the circulation of water and, around same, a system for heating the pipes of the circuit by means of induction coils. Said technique, which essentially seeks instantaneous heating, arranges coils around pipes through which the water is circulated.

One of the problems addressed by the present invention is that of providing an electric water heater which can operate with different power levels, which has good performance and is suitable for being easily combined with smart energy-management systems which are external to the water heater.

### SUMMARY

In order to achieve this objective, the invention provides an induction-heating device, intended for interacting with a water heater, including a power generator and an inductive module formed by at least one inductor and at least one load, the inductor being configured such as to generate an induced current in the load, characterised in that the inductor and at least one load are configured such as to be submerged in the heating body of the water heater.

Specifically, the water heater includes a heating body and an induction-heating device, including a power generator and an inductive module including at least one inductor and at least one load, the at least one inductor being configured such as to generate an induced current in the load, characterised in that said at least one inductor and at least one load are arranged submerged in the heating body.

The technical effect is that of guaranteeing a direct heat exchange between the inductive module, made up of an inductor and at least one load, and the water contained in the water heater. The inevitable heating of the inductor, which leads to losses, is recovered and also used to heat the water contained in the water heater. Placing the inductor in the water is not a routine solution for a person skilled in the art.

Thus, submerged is understood to mean that the inductor and the load are submerged and thus in contact with the water contained in the heating body. In an advantageous manner, an intermediate space between the inductor and the load allows for the presence of water between said two components.

The water heater according to the invention may also optionally have any of the following features:
the inductive module includes at least one coil as an inductor and said at least one load is in the form of a load plate, the plane of symmetry of the at least one coil and the plane of the plate being substantially parallel,
the at least one coil of the inductive module is substantially flattened and preferably is surrounded on each of the surfaces thereof by a load plate,
it includes two loads arranged submerged in the heating body,
the at least one coil has an oblong shape,
each load plate is substantially rectangular and has longitudinal edges curved towards the at least one coil, the load plates at least partially defining therebetween a parallelepiped shape,
at least one load plate has a plurality of through holes facilitating the circulation of the water through said load plate,
the inductive module includes at least one power printed circuit as an inductor,
the inductive module includes at least one coil in the form of a solenoid as an inductor and said at least one load includes a tube arranged concentrically with the at least one coil,
it includes two loads submerged in the heating body, an external load arranged such as to surround the inductor and an internal load arranged such as to be surrounded by the inductor,
at least one load tube has a plurality of through holes facilitating the circulation of the water through said load tube,
the inductive module includes at least one coil in the form of a solenoid as an inductor,
said at least one load includes at least one mobile electric conductor element held in the magnetic field of the at least one coil,
said at least one load includes at least one mobile ball held in the magnetic field of the at least one coil by a cage which is preferably arranged concentrically with the at least one coil,
the ball cage is configured such as to allow the agitation of the balls,
it includes an electrically insulating material surrounding said at least one inductor,
it includes a watertight material surrounding said at least one inductor,
the watertight material and the electrically insulating material form a single casing,
the casing is a shell overmoulded around said at least one inductor,
the casing is made of plastic, of composite resin,
said at least one load of the inductive module is electrically conductive and preferably has magnetic permeability, advantageously high relative magnetic permeability.
said at least one load is configured such as to deform during heating or is coated with a food-grade component having non-stick properties, such as to limit the deposition of scale on said at least one load during the heating thereof,
it includes a mounting of the at least one inductor of the inductive module arranged between said at least one inductor and at least one load,
the power generator has an interface provided with a communication module built into the generator, said module enabling the remote control of heating parameters such as power, heating time and starting or stopping the heating,
the power generator is arranged outside of the heating body,
said at least one load is made of a material with a Curie point lower than a maximum predetermined temperature for the water of the water heater, and preferably lower than 100° C.,
the mounting passes through the water heater via a hatch, the mounting including a first portion supporting the inductor, submerged in the heating body, and a second portion extending the first portion outside of the heating body towards the power generator, the first portion advantageously being wider than the second portion and abutting against a closing plate covering the hatch, said closing plate having a large enough opening to allow the second portion to pass therethrough,
the closing plate includes a connector for receiving an inlet pipe for water to be heated,
the inductive module is arranged with the longitudinal axis thereof following the longitudinal axis defining the length of the heating body, for example over at least one length between one eighth and half the length of said heating body,
the water heater is a so-called flat water heater, with a substantially parallelepiped shaped heating body,
it includes a plurality of longitudinal channels which are juxtaposed and in fluid communication with one another, at least one of the longitudinal channels receiving the inductive module of the induction-heating device,
the inductive module is arranged centrally relative to the thickness and the width of the heating body,
in order to cool same, the induction generator exchanges with an area for the circulation of water to or from the heating body,
the inductive module defines a water passage between the inductor and said at least one load, said inductor exposing the water to a magnetic field which prevents the furring of said at least one load,
the heating body has a capacity of more than 10 litres, preferably 20 litres.

According to another aspect, the invention relates to a load of an inductive module according to the various embodiments described hereunder.

According to another aspect, the invention relates to an inductive module including a load and an inductor according to the various embodiments described hereunder.

### BRIEF DESCRIPTION OF THE DRAWINGS

Further characteristics, aims and advantages of the present invention will emerge from reading the following detailed description and from looking at the appended drawings provided as non-limiting examples, in which:

FIG. 1 is a diagrammatic depiction of a longitudinal section of one embodiment of a portion of a water heater according to the present invention, the water heater being flat and being provided with an induction-heating device. It should, however, be kept in mind that induction heating can be carried out using water heaters that have other shapes than a flat water heater, in particular cylindrical.

FIG. 2 is a diagrammatic depiction of a front view of a water heater according to one embodiment of the invention, the water heater being flat and being provided with an induction-heating device,

FIG. 3 is a diagrammatic depiction of a perspective longitudinal section of one embodiment of a water heater according to the present invention, the water heater being flat and being provided with an induction-heating device,

FIG. 4 is a diagrammatic depiction of a longitudinal perspective view of an embodiment of an inductive module with an oblong coil and a substantially rectangular load plate according to the present invention,

FIG. 5 is a diagrammatic depiction of a perspective view of an inductive module according to FIG. 4, with two load plates.

### DETAILED DESCRIPTION

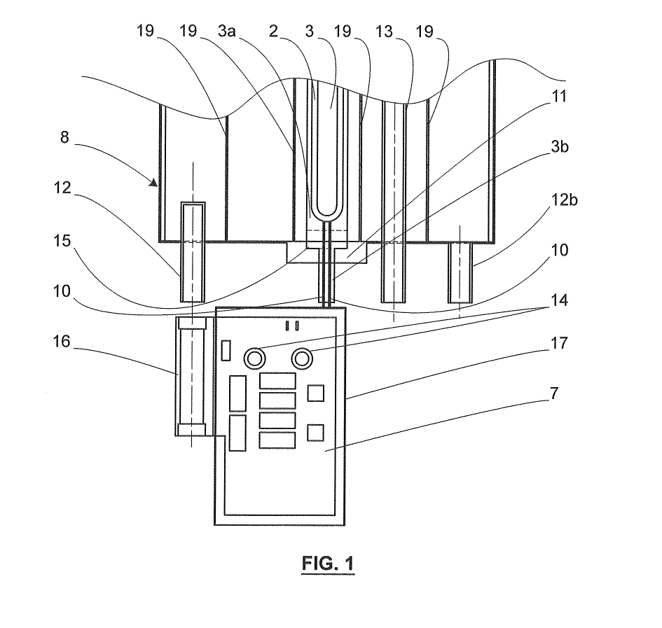

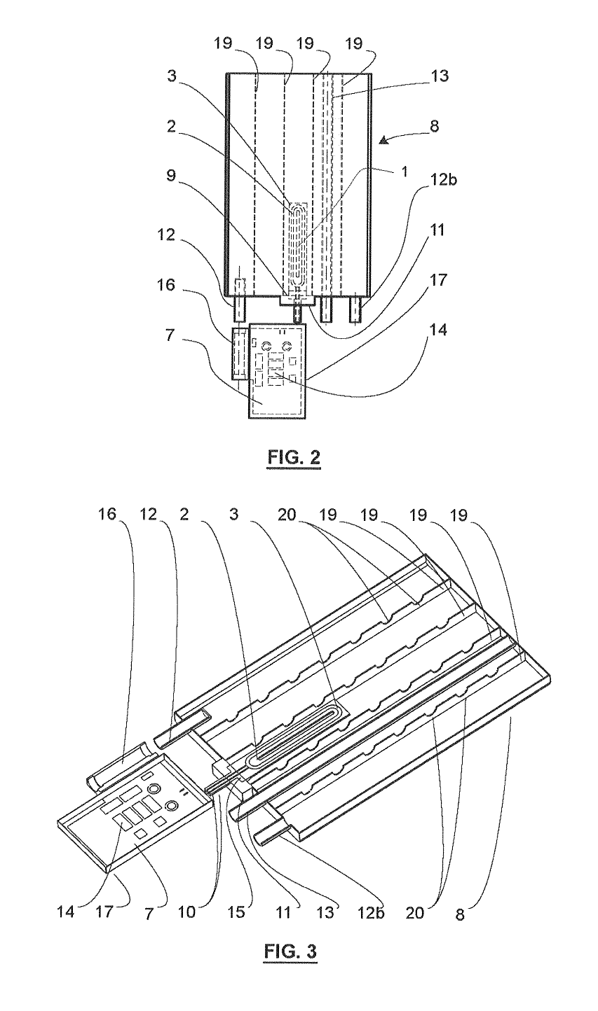

The water heater depicted in FIGS. 1 to 3 includes a heating body intended for receiving a volume of water, an inlet pipe for water to be heated 12, an outlet pipe for heated water 13, and advantageously a drain pipe 12b intended to allow the complete emptying of the heating body. The inlet pipe for the water to be heated 12 advantageously leads into the bottom portion of the heating body, preferably near the inductive module which makes it possible to heat the water. The outlet pipe for heated water 13 makes it possible advantageously to collect the water from the top portion of the heating body. The water heater is advantageously of the storage type, which means that the water is not in dynamic circulation. The water heater thus has water-heating phases and water-bleeding phases which are generally separate and not connected.

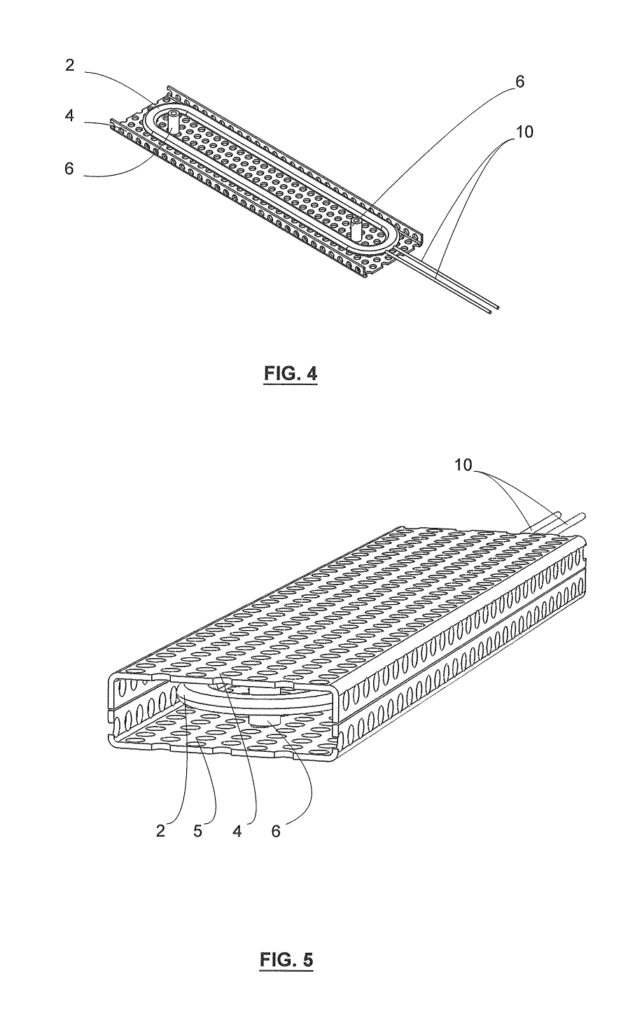

In general terms, in reference to FIGS. 1 to 5, it is important to remember that an induction-heating device 1 uses a power generator 7 which has the role of transforming the low-frequency current of the electricity supply system—generally 50-60 Hz—into high frequency. Said current is used to supply at least one inductor 2 in the form of at least one induction coil made up mainly of a conductive winding, in addition to magnetic circuits, and electric and thermal insulators.

The power generator 7 includes a printed circuit on which various components 14, including power components in which the losses are emitted in the form of heat, are assembled. Said power components are thermally secured to a heat sink, preferably made of aluminium. Said heat sink is configured such as to dissipate the heat emitted by the power components such as to prevent the overheating thereof. The generator 7 can be housed in a receiving box 17 intended for protecting same and/or for insulating same electrically and/or for isolating same from the water. The receiving box 17 defines the outer contour of the generator 7 and can have a substantially rectangular or even circular shape. The generator 7 is connected to the inductor 2 by electrical connectors 10.

The coil 2 through which the high-frequency current passes generates a magnetic field with variable frequency in the near environment thereof. The coil 2 is advantageously supported by a mounting 3.

An electrically conductive object, often referred to as load 4, 5 and submerged in said variable field, has induced currents, also referred to as eddy currents, passing therethrough, which cause the heating thereof by the Joule effect. The loads 4, 5 are advantageously in the form of load plates surrounding the inductor 2. The plates can be two separate plates arranged symmetrically relative to the plane of the inductor 2 or else a single part bent such as to form two symmetric loads relative to the plane of the inductor 2. The loads 4, 5 are kept separated from the inductor 2 by spacers 6, advantageously electrically insulating, for example distributed at the four corners of the load plates, 4, 5 with an advantageously rectangular shape or else in the central position of the loads 4, 5. The load plates 4, 5 are advantageously secured to the mounting 3.

The assembly of the at least one inductor 2 in the form of at least one coil and at least one load 4, 5 is referred to as inductive module. In the subsequent description, the inductive module comprises two loads 4, 5 and one inductor 2 without having any limiting effect.

According to the invention, the inductor 2 is electrically insulated and isolated from the water such as to be sealed. The inductive module includes an electrically insulating material and a watertight material. These can be the same single material or a plurality of materials.

According to a preferred embodiment of the invention, the inductive module includes a casing comprising the properties of tightness and electrical insulation.

According to a first example, the winding is covered with a high-temperature insulator for electrical insulation. It is necessary in parallel to provide water isolation in order to make the inductor 2 watertight. The winding is, for example, cast or overmoulded using a sealing material. For example, an epoxy resin or a plastic.

The materials used and; advantageously, those in contact with the water to be heated have food-grade properties.

If the sealing material is also an electrical insulator, it is not necessary to provide a winding covering the insulator.

According to a second example, it can be provided for the actual wire of the coil to be configured such as to be sealing and electrically insulating, for example a wire intended for being submerged.

Advantageously, the casing of the inductor 2 constitutes a mounting 3 of the inductor 2. Preferably, overmoulding allows the production of a mounting 3 with various shapes. The mounting 3 is, for example, in the shape of a mounting plate with dimensions similar to those of the load plates 4, 5. The mounting plate is inserted between the load plates which are substantially parallel to one another. The spacers 6 preferably keep the three plates 3, 4, 5 spaced apart.

The water heater 8 according to the invention includes a heating body intended for containing water and heating means intended for heating the volume of water contained in the heating body.

An induction-heating device 1 undergoes losses which can represent 5% of the transmitted power, or even more if the winding of the coil 2 is manufactured under major economic constraints. Said losses greatly limit the extended heating of the vessel acting as heating body and often require ventilation of the heating device, and mainly of the inductor thereof in the form of a coil. This makes the cost of such a device prohibitive if it is placed outside the water heater, making it noisy to use the device.

It is also necessary in many cases to cool, by means of a heat sink and forced ventilation, the so-called electronic power components of the device generator. The latter also have a non-negligible loss level, which contributes to lowering the performance of the device.

In order to at least partially compensate for the aforementioned losses, the present invention provides for the inductor 2 to be housed inside the heating body, preferably directly in the water contained in the heating body, at least one load 4 or 5 also being submerged in the water.

This is based on the observation that the main losses of the induction-heating device 1 take place through the inductor 2. In this manner, the inductor 2 and at least one load 4, 5 exchange their losses with the water, and said losses are thus recovered such as to heat the water of the water heater 8.

The inductor can be similar to that used in an induction hob, the inductor being of the flat-coil type, also known as a pancake coil. Said type of coil is perfectly symmetrical, which means that the magnetic field is generated equally on both surfaces. One surface is conventionally provided with a magnetic circuit which provides the role of channelling the field, generally on the bottom of the inductor, and of returning same towards the load, generally resting on the top portion of the coil forming the inductor.

By extrapolating said features to the induction-heating device 1 according to the invention and thus by providing a flat coil generating a magnetic field on two surfaces as an inductor 2, a load 4, 5 to be heated on each surface of the flat coil is also used, said loads 4, 5 having adequate ferromagnetic features. It is thus also possible to save on one magnetic circuit in inductor 2.

Flat or flattened is understood to mean that the thickness of the coil is less than said other dimensions, in particular than the length and width. The coil therefore has two opposing, parallel surfaces. The coil advantageously has an oblong shape. The length thereof is greater than the width thereof.

This also makes it possible to increase, or specifically to double, the exchange surface and thus to reduce the loss of power, enabling a better exchange of energy with the water. The inductor 2 and the loads 4, 5 thereof, of which at least one and preferably both are submerged, are thus made up, as a non-limiting example, of a central flat coil and two ferromagnetic plates 4, 5 magnetically coupled with the coil 2. Said two plates 4, 5 are the source of eddy currents when the coil 2 is supplied by the generator 1 and are operational for heating the water.

Said configuration also has the advantage of being particularly fine, for example with a thickness of 3 cm, which facilitates the integration thereof in specific embodiments of water heaters 8, such as flat water heaters.

It may be possible to save on the cost of the induction-heating device 1, in particular on the inductor 2. This can be done, for example, by manufacturing the winding in a less complicated manner than that imposed by good engineering practices. This can be done by minimising, for example, the section of the winding or by manufacturing the winding using a solid conductor or even a power printed circuit.

In this case, the losses are greater, but are calculated such as to be acceptable for the device 1 knowing that they are transmitted to the water and thus are transformed into recovered energy.

Other shapes of the induction coil 2 than an induction coil that is flat on the two surfaces thereof can be contemplated. A coil 2 which can be used in the context of the invention can be in the form of a solenoid with internal and/or external loads, such that the loads can also act as magnetic circuits, as in the case of two load plates 4, 5.

The one or more loads 4, 5 are in the form of a tube advantageously having a circular section extending over substantially the entire height of the inductor 2. The load tubes 4, 5 are arranged concentrically with the solenoid coil.

An internal load tube is arranged inside the coil and an external load tube is arranged outside the coil. The internal load is surrounded by the coil, while the external load surrounds the coil.

As for the plates, the load tubes 4, 5 are preferably perforated to improve the circulation of water.

According to an advantageous possibility, the internal load tube 4, 5 can be the inlet pipe for the water to be heated 12, submerged in the heating body. Advantageously, the inlet pipe for water to be heated 12 can support the inductive module: the inductor 2 and the at least one submerged load 4, 5.

In order to facilitate the assembly of the water heater, the inlet pipe for water to be heated 12 is secured to the closing plate 11 of the inspection hatch 9 of the water heater.

In order to allow cooling of the generator 7, the inlet pipe for water to be heated 12 is advantageously thermally connected to the heat sink supporting the power components 14 of the generator 7.

The loads 4, 5 are made of electrically conductive materials which can be magnetic or non-magnetic.

The magnetic materials for the loads 4, 5 are more advantageous for heating than the non-magnetic materials.

It is also possible to manufacture the loads 4, 5 using a low-thickness conductive, non-magnetic material, said low-thickness, conductive, non-magnetic materials, for example aluminium of the order of 100 micrometres, being preferably attached to a non-magnetic, non-conductive substrate ensuring the mechanical resistance thereof.

The loads 4, 5 can have specific shapes or surface conditions that make it possible to improve the heat exchange with the water, as well as to optimise the coupling with the induction coil 2, while preventing furring as much as possible.

According to a preferred possibility, the load plates 4, 5 are substantially planar and include a plurality of through holes of several millimetres. The through holes improve the circulation of water and thus the heat exchanges around the inductive module without losing efficiency.

In this case, it should be considered that the loads 4, 5 become the heating elements, and thus that the scale tends to deposit on the loads 4, 5 instead of on the coil 2. Said phenomenon is, however, minimised since, for a given power, the power density is much lower and thus the surface is less hot. It should also be noted that the risk of breakage of the heating element by overheating disappears since the loads 4, 5 are purely passive and cannot be affected by possible overheating.

Since the Curie point is the temperature above which the magnetic permeability of a ferromagnetic material reaches μr=1—i.e. the material becomes non-magnetic—the phenomenon of induction acts up until the Curie point of the materials that make up the loads 4, 5. It may thus be advantageous, in a simply illustrative and non-limiting manner, to manufacture the loads 4, 5 using a material having a low Curie point, preferably less than 100° C., for example 90° C. or less.

In this case, the inductor 2 indirectly heats the loads 4, 5 while the temperature thereof does not exceed 100° C. Beyond said temperature, the material passes its Curie point and becomes non-magnetic, which means that the magnetic flow of the coil is no longer channelled through the load, producing a very considerable reduction of the active portion of the impedance of the coil, rendering impossible the operation of the generator. Heating only resumes after the material of the loads 4, 5 cools and its temperature drops below the Curie point, in other words into the ferromagnetic zone.

The production of loads 4, 5 in such a ferromagnetic material with low Curie point can ensure absolute and additional thermal safety for the inductor 2 and the heating device 1 containing same.

It is also possible to optimise the shape, material and/or attachment of the loads 4, 5 such that the latter can deform when heating, said deformations preventing or removing the fur that may have covered same. Deformable materials, for example with shape memory, can be used.

Finally, it may also be interesting to perform a surface treatment which makes it possible to ensure the compatibility of the loads 4, 5 with food standards and to minimise furring by means of non-stick properties.

Generally speaking and in particular according to an embodiment including an inductor 2 in the form of a solenoid with internal and/or external loads 4-5 with circular section, it may be provided for the loads 4-5 to be at least partially in the form of at least one mobile electrically conductive element held in a zone advantageously at least partially matching the zone of action of the field of the inductor 2. The at least one conductive element is preferably free of movement in said zone. The at least one conductive element is advantageously configured such as to be moved by the flows of water in the heating body, specifically in the zone of action of the field of the inductor 2. In order to move the at least one element, it is preferable for the inlet pipe for water to be heated 12 to be placed under the inductor 2 such that the injection of water into the heating body ensures the agitation of the at least one element. Said agitation limits the deposition of limescale and optionally facilitates the removal thereof, in particular by the crashing of the at least one element with another at least one element or else with the holding means described above. The at least one element has a shape and/or properties which limit the binding of the limescale and/or facilitate the removal thereof. The at least one element is held in the zone of action of the field of the inductor 2 by a holding means, for example by a shaft on which the at least one element is mobile with to at least one degree of freedom or, for example, by a cage delimiting the zone in which the at least one element must be held, leaving same free to move according to every degree of freedom.

According to one embodiment, the at least one element is at least one ball. Preferably, the loads 4, 5 are balls held in a zone advantageously corresponding at least partially to the zone of action of the field of the inductor 2. Said zone is preferably defined by a cage, for example made of layers forming an electric screen, optionally conductive, shaped such as to define a space for receiving the balls.

The balls are, for example, made of ferromagnetic materials which are heated by the field induced by the inductor 2. The balls can have various shapes: with a circular or cylindrical section, among others. The balls of the same load 4, 5 can have different shapes. The balls are configured to make it possible to produce a load and thus adequate induction heating, as well as to minimise the incrustation of scale and optionally to facilitate the removal thereof.

The cage is configured to allow a movement of the balls and in particular the crashing among same. The actual shape of the balls, advantageously with circular section, limits the deposition of scale. Moreover, the crashes between the balls facilitate the removal of the deposited scale. Preferably, the cage of each load 4-5 is made of a non-conductor material such as not to heat up and not to risk becoming furred. The cage is configured to enable a heat exchange between the balls and the water that is efficient as possible.

For example, the balls are held in an annular area that is concentric with the coil.

According to an embodiment wherein at least one load 4, 5 is in the form of an internal ball cage arranged inside the inductor in the form of a solenoid, the internal cage is advantageously formed by the solenoid. The balls are placed in the inner volume defined by the solenoid, the ends of the solenoid are closed by a wall, preferably a screen in which the mesh size is smaller than the smallest section of the balls such as to hold the balls while allowing any scale that is loosened from the balls to pass through same, as well as to ensure good circulation of the water around the balls.

The external ball cage is preferably formed by at least one tubular screen surrounding the inductor 2.

According to a preferred possibility, the loads 4-5 are secured to the closing plate 11, as is the inductor 2, such as to facilitate the placement and the removal of the inductive module.

The structure of said loads 4-5 is advantageous since it facilitates the circulation of the water around and in the inductive module.

The balls have a size, for example, of around 15 mm. Each load 4-5 can be made up of 10 to 30 balls. The exchange surface is at least comparable with that of a load having rectangular shape.

It is preferable for the balls to be light in order to facilitate the agitation thereof. Moreover, the phenomenon of induction occurs on a so-called “skin” thickness. It is thus possible to reduce the thickness of the conductive material of the at least one conductive element.

The rest of the description is made in reference to the ball, without implying any limitations. A ball can be solid or hollow with only a casing of conductive material. The load can be made up of balls of different nature.

For magnetic materials, a thickness of 0.5 mm for a ball diameter of 15 mm and a field frequency of 20 KHz is sufficient, the core being hollow or made of a material which is preferably lighter than the conductive material.

For non-magnetic materials, it is preferable for the ball to include a low-thickness, conductive, non-magnetic casing such as not to cause inadequate impedance in the inductor. In this case, it is preferable for the thickness of the casing to be less than the thickness of the skin, in a preferred example of the order of 1/10 of the thickness of the skin. The core is hollow or made of a non-conductive material and preferably lighter than the conductive material.

The ferritic balls are simultaneously subjected to the frequency under consideration, with an effect of attraction linked to the magnetic permeability thereof and with an effect of repulsion linked to the induced currents, the resultant being almost zero. On the other hand, the non-magnetic balls in which the conductive layer has a thickness of around 1/10 of the thickness of the skin are only subjected to the repulsion force linked to the induced currents referred to as the Laplace force. Said force can be, according to the weight of the balls, sufficient to cause the movement thereof and the crashes among same which have a descaling effect, said phenomenon being enhanced if it is accumulated with the water flow generated by the output of the pipe for water to be heated 12.

According to the prior art, there are many embodiments of magnetic anti-scale systems, either with permanent magnets, or with coils creating variable magnetic fields in frequency ranges that can reach 100 kHz. Electronic anti-scale appliances using said principles, although expensive, still have modest power of no more than several tens of volt-amperes and generate weak fields of several tens of ampere-metres.

On the other hand, the submerged inductor 2 used in the device 1 according to the present invention has a high power of several thousand volt-amperes and generates particularly high fields, higher than 1000 ampere-metres in the air gap between the inductor 2 and the loads 4, 5 and in the same frequency ranges of 20 to 50 kHz. It can therefore be interesting to make it such that the inlet of cold water or simply a water circulation takes place between the loads 4, 5, such that the water passes through an intense magnetic field. The intense magnetic field can thus act on the ions in suspension in the water and cause an effect of not depositing said ions on the hot elements, in other words an effect of preventing the precipitation of the limescale as fur. This can therefore be a beneficial consequence of adopting the inductor 2 submerged in the water heater 8, which is not however the main effect sought.

It is possible to force the circulation of water between the loads 4, 5 by forming specific geometries, for example, by bending one of the sides of the plates 4, 5, such that the two opposing plates 4, 5 form a kind of rectangular box, at the centre of which the induction coil 2 is arranged and through which the cold water arriving from the water heater 8 passes.

A closed shape of this type can also be of interest in the context of using vessels which serve as heating bodies which are non-metallic or made of composite materials. In this case, it is convenient to channel as best as possible the magnetic field emitted by the winding. A closed geometry advantageously enables channelling of the magnetic flows and thus makes it easier to comply with standards relative to electromagnetic disruptions.

An inductor 2 submerged in the water of the water heater 8 is also interesting since it provides a complete electronic system, for example:
very fine temperature regulation by means of at least one submerged NTC (Negative Temperature Curve) sensor, i.e. a sensor in the form of a thermistor in which the resistance drops in line with the temperature. As an alternative, a PTC (Positive Temperature Curve) sensor can be used, i.e. a sensor in the form of a thermistor in which the resistance increases in line with the temperature. The temperature can thus be regulated with predefined heating cycles, or the demand for hot water can be anticipated at specific times or calculated by teach programming; indeed, existing water heaters are provided with thermostats which are adjusted permanently at the plant or by the installer and which cannot be adjusted by the user. And yet, it is known that the hotter the water, the greater the loss through natural cooling. It may therefore be interesting, for the purpose of minimising the losses, not only to plan the heating by teach-programming in accordance with the demand, but also to adjust the temperature or temperatures of the heating body to optimal values as required.
to know and finely control the power injected into the one or more inductors 2.

The latter advantage is particularly important in the case of new energies and the uses thereof. Indeed, it is possible to communicate rapidly with the energy management systems in order to match the drawn energy with the available energy, as well as to finely adjust the energy until very low and/or very high powers, while maintaining high performance.

An inductor 2 submerged in the water of the water heater 8 is particularly advantageous relative to an inductor which directly heats the vessel which acts as a heating body. Indeed, this allows for electrical insulation of the loads 4, 5 receiving energy from the vessel which acts as a heating body and thus from the earth and, thus, allows for considerably reduced dimensions of the electronic filters in charge of eliminating the shedding from the high-frequency components towards the power supply system or the ground.

It may be possible to apply to the electronic components 14 of the power generator the same principle as for the inductor 2, namely securing said components of a minimalist heat sink thermally connected to the vessel acting as heating body and thus to the water as close together as possible.

When the water of the water heater 8 is cold, the demand for power is maximum and thus the demanded energy is high, stressing the components 14 of the power generator 7 which are then kept below around 100° C. The water is then adjusted such as never to exceed 60° C., for example, at the bottom of the vessel and thus acts as an excellent heat sink for the losses of the components 14 of the generator 7 which then play a role, although to a lesser extent than the inductor 2, in the performance of the heating device.

When the water begins to heat up, the dissipation effect is smaller, but so is the energy demand, and thus said components 14 of the power generator 7 can still be effectively cooled. This enables a considerable reduction in the size of the heat sink and an overpressure of the ventilation conventionally used for the power generator 7 in household induction-heating devices 1.

As an illustrative and non-limiting example, the invention has been applied to a 100-litre water heater 8. In the induction-heating device 1, the inductor 2 is a serial half-bridge inverter with a maximum power of 3,700 watts corresponding to a current of 16 amperes under 230 volts.

The inductor 2 is, for illustrative and non-limiting purposes, a flat coil with dimensions of 55×340×4 mm, positioned vertically in the water heater 8. The flat coil 2 is made up of 24 turns of multi-strand enamelled wire providing the first electrical insulation, the number of turns and the distance with the plates 4, 5 making it possible to ensure that the resonant power generator 7 has an impedance which is compatible with the power to be transmitted.

Advantageously, the induction coil is a winding of a strand of stranded wire of a solid conductor made of copper or aluminium. The winding is, for example, then overmoulded with an electrically insulating material that makes it possible to provide the necessary insulation for the submerged component, said material in contact with the water furthermore having food-grade properties. An NTC component is positioned at the centre of the winding and overmoulded with same. It provides, as a sensor, the reading of the temperature that will enable fine adjustment of the inductor 2. It is easy to manage a plurality of multiplexed sensors and thus to obtain precise temperature information at a plurality of points inside or outside of the heating body or of the components inside or outside of the heating body

Two ferritic plates, with a thickness that can advantageously vary from 6/12 to 12/10 and which can be bent at 90° on one side such as to form a parallelepiped when they are mounted facing one another, are positioned on either side of an inductor winding at a distance of 6 mm, allowing water to circulate between the plates 4, 5 and the inductor 2. Advantageously, the plates 4, 5 have dimensions of 380 mm×270 mm.

According to a preferred embodiment, the loads 4, 5 are secured to the mounting 3, advantageously made of plastic or composite, which in turn advantageously at least abuts with or is secured to the closing plate 11 of the inspection hatch 9 of the water heater 8, such that the loads 4, 5 are electrically floating.

The inductor 2 and advantageously the temperature sensor are electrically connected via electrical connectors 10 to the generator 7, advantageously secured to the other side of the closing plate 11 of the hatch 9 and thus outside of the water heater 8. The power components 14 of the generator 7 can be thermally connected to the closing plate 11 of the hatch 9 and thus can also dissipate the heat thereof into the water of the vessel which acts as a heating body.

The generator 7 is connected to a control interface positioned on the front of the water heater 8 and is optionally capable of displaying the operating and status parameters of the water heater 8 and of the power grid. Said interface is, for example, provided with a module for communicating with a local communication network. Such a network makes it possible to exchange information on the consumption of the water heater 8 with the central system for managing electric energy and also to be operated by said system.

The induction-heating device 1 according to the present invention is arranged next to and in the median lower portion of the water heater 8, the generator 7 being arranged on the outside, advantageously under the water heater 8 when the latter extends vertically.

The inductor 2 of the device 1, connected to the generator 7 by electrical connections 10, like the mounting plate 3 thereof, is arranged inside the water heater 8 by penetrating into said water heater 8 via the hatch 9 provided in the median lower portion of the water heater 8.

One advantageous possibility consists of proposing an induction kit, namely a closing plate 11 of the hatch 9 supporting the inductive module as well as the power generator 7. It is thus possible to provide the water heater with induction heating means without affecting the mechanics of the water heater, simply by inserting the kit. For example, the power generator 7 can be round or rectangular, hinged about the cold water inlet tube 12 and secured to the closing plate 11.

The oblong shape of the coil and, generally, of the inductive module facilitates the installation and removal thereof in the heating body via the hatch 9 with the smallest dimensions, improving the resistance to the pressure of the water heater.

In the case of the round shape of the solenoid coil and of the loads thereof in the form of balls constrained to move in a confined zone exposed to the field of the induction coil, the cage also has a shape which facilitates the installation and removal of the inductive module in the heating body.

The various alternatives relating to the inductive module and to the loads are not exclusive and may be combined.

According to a preferred embodiment, the inlet for water to be heated 12 in the heating body is arranged vertically in line with the inductive module. Said arrangement allows the intake of water into the heating area, thus improving the circulation of the water. The inlet pipe for water to be heated 12 is preferably arranged on the closing plate 11.

The inductor 2 extends over a portion of the length of the water heater 8. The inductor is arranged in the bottom portion of the water heater. As a non-limiting example, the inductor 2 takes up at most half the length of the water heater, preferably between one eighth and one quarter of the length of the water heater 8.

According to one embodiment, the mounting 3 of the inductor 2 has a first portion 3b, overmoulded around the coil which is, for example, flat forming the inductor 2, and said portion 3b is intended for being completely inserted in the water heater 8, the coil which is, for example, flat forming the inductor 2 being covered by the casing thereof.

As previously mentioned, inside the coil forming the inductor 2, advantageously at the mid-length of the coil, at least one temperature sensor, for example an NTC or PTC sensor, can be provided, said temperature sensor being submerged inside the water heater 8 and outputting temperature values which are transmitted to the generator 7 of the device 1.

The mounting 3 also comprises a second portion 3a, with a smaller width than the first portion 3b, said second portion 3a being located outside the water heater 8 and extending the first portion 3b towards the generator 7 by only supporting the electrical connections 10. The junction between the first 3b and second 3a portions with smaller width has, for example, side shoulders 15.

The hatch 9 can have, for example, a rectangular outer shape which renders same substantially different from that of the hatch with a generally circular shape for the passage of the electrical heating element in a water heater of the prior art. The hatch 9 is closed by at least one closing plate 11, secured to the hatch 9 by removable securing means such as screws, with a sealing gasket advantageously inserted therebetween. The closing plate 11 comprises a central rectangular opening which is just large enough to allow the second portion 3a of the mounting plate 3 to pass therethrough, the shoulders 15 supported by the first portion 3b of the supporting plate 3 at the junction thereof with the second portion 3a abutting internally against the closing plate 11. The closing plate 11 can be secured to the mounting 3 directly when overmoulding the coil 2 with a plastic material.

The water heater according to the invention includes heat-exchange means. Advantageously, the heat exchanger is an exchanger with water circulation, preferably of water to be heated, for example the water that supplies the water heater 8 passing through at least one inlet pipe 12 for water to be heated.

The heat-exchange means according to the invention include the heat sink to which the power components are thermally connected. According to one possibility, the heat sink includes a portion forming a casing for discharging the heat produced during the operation of the generator 7, together with the water heater 8. For this purpose, a circuit is provided for circulating water towards the heating body. Enclosure is understood to refer to an interface between the water-circulation circuit and the power components. The casing is understood to be the heat sink surrounding the circuit for circulating the water towards the heating body. The circulation circuit is preferably connected to the inlet pipe 12 for water to be heated.

According to one possibility shown, the casing is reduced to a sleeve 16 interacting with a portion of the inlet pipe 12 for water to be heated. The casing can be thermally linked to the water-circulation circuit or even form the water-circulation circuit. In the latter case, the water circulates directly in the casing.

According to one possibility, the assembly includes an additional circuit. A water tap can be provided from the inlet pipe 12 such as to form an additional water-circulation circuit inside the housing 17.

It is also possible, when the sleeve 16 is not used to discharge heat from the generator 7, being replaced by another heat-exchange means or complementing such a heat exchange, for the sleeve 16 to serve the main or additional function, respectively, of securing the housing 17 of the generator 7 relative to a water inlet pipe 12, which is advantageous for holding the housing 17.

For cooling purposes, the power generator 7 is thermally connected to the water heater, specifically to the heat sink supporting the power components of the generator 7.

According to a preferred embodiment, the generator 7 and specifically the heat sink is thermally isolated such as to limit the heat exchanges with the outside air and to concentrate the heat exchanges with the circulation zone of the water towards or inside the heating body.

Other heat exchange configurations between the power generator 7 and the water to be heated of the water heater 8, in other words the water contained in or arriving in the heating body 8, are also possible.

For example, as an alternative or in addition to the water-circulation circuit, the generator 7 may be attached to the outside of the heating body in a zone that is not thermally insulated, with a heat exchanger advantageously arranged between the heating body and the generator 7, specifically with the heat sink thermally connected to the heating body.

In one alternative, the zone of the heating body which is not thermally insulated is the closing plate 11. The power components of the generator 7 can be thermally connected to the closing plate 11 of the hatch 9 described below, preferably via the heat sink, dissipating their heat indirectly into the water contained in the heating body. In said alternative combined with the presence of the water-circulation circuit, the inlet pipe for water to be heated 12 can be secured to the closing plate 11. The inlet pipe for water to be heated 12 is preferably made of aluminium and enables an improved heat exchange.

For example, in an alternative or additional manner, the power generator 7 can be arranged submerged in the heating body of the water heater 8, with or without a heat exchanger arranged between the water contained in the heating body and the generator 7.

According to one variant, only the heat sink is arranged submerged in the heating body, the rest of the generator 7 being outside the heating body. Direct conduction exists between the heat sink and the water. For example, a single part of anodised aluminium extending inside and outside can serve as a connection to the pipe for water to be heated 12, as a heat sink for the power components, as an external mounting for the power generator and as an internal mounting for the inductive module. The advantage of said single part is that it combines the function of heat sink by conduction and convection due to the circulation of the water to be heated.

The cooling of the generator 7 is possible even according to the embodiment including a water circuit towards the heating body and even when the heating body is not filled, by convection. Indeed, the heat exchange produced by the exchange means heats the water in the circulation zone and cools the generator 7 locally, specifically the heat sink, since the water from the heated circulation zone undergoes convection movements that move said water away from the circulation zone and move cooler water closer, creating a convective flow. Advantageously, said effect is reinforced by the arrangement of the generator 7 below the vessel of the water heater and the movement of the hot water that rises towards the vessel. According to a preferred embodiment, the exchange means are positioned as close as possible to the heating body

FIGS. 1 to 3 show a longitudinal section view of the lower portion of a water heater 8 in the form of a so-called flat water heater. Said flat water heater, i.e. substantially parallelepiped-shaped, includes an inlet pipe 12 for water to be heated and a drain pipe 12b as well as an outlet pipe for water to be heated 13. Regularly spaced inserted walls 19 are provided, extending across the entire length of the water heater 8, for example four inserted walls 19 for the water heater 8.

Said inserted walls 19 have a width which is equivalent to the thickness of the water heater 8, thus defining longitudinal channels for the circulation of water between same. An inductive module 2 of the induction-heating device 1 is located in such a channel, preferably in the one that is at the middle of the water heater 8.

The inserted walls 19 have openings 20 at regular intervals which communicate two adjacent channels with one another. Said inserted walls 19 also act as reinforcements of the water heater 8, in addition to enabling the circulation of water in the heating body.

The inductive module is advantageously placed in the heating body such that the thickness thereof is arranged according to the thickness of the body of the water heater. In the embodiment with channels and inserted walls 19 provided with openings 20, the inductive module thus placed facilitates the circulation of water through the opening 20 and around the load plates 4, 5.

In another embodiment, the longitudinal channels advantageously correspond to a plurality of vessels. For example, the water heater 8 may be made up of three vessels acting as cylindrical elementary heating bodies. Said vessels advantageously have a section which is substantially equivalent to the section of a longitudinal channel.

### REFERENCES

1. Device
2. Inductor
3. Mounting
3a. First portion
3b. Second portion
4. Load
5. Load
6. Spacer
7. Generator
8. Water heater
9. Hatch
10. Electrical connection
11. Closing plate
12. Inlet pipe
12b. Drain
13. Outlet pipe
14. Components
15. Shoulder
16. Sleeve
17. Box
19. Inserted wall
20. Opening

1. A water heater including a heating body and an induction-heating device, including a power generator and an inductive module including at least one inductor and at least one load, the at least one inductor being configured such as to generate an induced current in the at least one load, wherein that the at least one inductor and the at least one load are arranged submerged in the heating body such as to be capable of being submerged in the water of the water heater.

2. The water heater according to claim 1, wherein the at least one inductive module includes at least one coil as an inductor and said at least one load includes a load plate, a plane of symmetry of the at least one coil and a plane of the plate being substantially parallel.

3. The water heater according to claim 2, wherein the at least one coil of the at least one inductive module is flattened and surrounded on each of the surfaces thereof by a load plate.

4. The water heater according to claim 2, wherein the at least one coil has an oblong shape.

5. The water heater according to claim 3, wherein each load plate is rectangular and has longitudinal edges curved towards the at least one coil, the load plates at least partially defining therebetween a parallelepiped shape.

6. The water heater according to claim 2, wherein the at least one load plate having a plurality of through holes facilitating circulation of the water through said at least one load plate.

7. The water heater according to claim 1, wherein the at least one inductor includes the at least one coil in the form of a solenoid.

8. The water heater according to claim 1, wherein the at least one inductive module includes the at least one power printed circuit as the at least one inductor.

9. The water heater according to claim 1, wherein the at least one inductive module includes the at least one coil in the form of a solenoid as the at least one inductor and said at least one load includes at least one load tube arranged concentrically with the at least one coil.

10. The water heater according to claim 9, including two loads submerged in the heating body, an external load arranged such as to surround the at least one inductor and an internal load arranged such as to be surrounded by the at least one inductor.

11. The water heater according to claim 9, wherein the at least one load tube has a plurality of through holes facilitating the circulation of the water through said at least one load tube.

12. The water heater according to claim 2, wherein the at least one load includes at least one mobile electrically conductive element held in the magnetic field of the at least one coil.

13. The water heater according to claim 12, wherein said at least one mobile electrical conductive element includes the at least one mobile ball held in the magnetic field of the at least one coil by a cage.

14. The water heater according to claim 13, wherein the ball cage is configured such as to allow the agitation of the balls.

15. The water heater according to claim 1, including an electrically insulating material surrounding said at least one inductor.

16. The water heater according to claim 1, including a watertight material surrounding said at least one inductor.

17. The water heater according to claim 15, wherein the watertight material and the electrically insulating material form a single casing.

18. The water heater according to claim 17, wherein the casing is a shell overmoulded around said at least one inductor.

19. The water heater according to claim 1, including a mounting of said at least one inductor of the at least one inductive module arranged between said at least one inductor and the at least one load.

20. The water heater according to claim 1, wherein said at least one load is configured such as to deform during heating or is coated with a food-grade component having non-stick properties, such as to limit the deposition of scale on said at least one load during the heating thereof.

21. The water heater according to claim 1, wherein the power generator is arranged outside the heating body.

22. The water heater according to claim 1, wherein said at least one load is made of a material with a Curie point lower than a maximum predetermined temperature for the water of the water heater and preferably lower than 100° C.

23. The water heater according to claim 1, wherein the heating body is parallelepiped-shaped.

24. The water heater according to claim 1, wherein the at least one inductive module is arranged with the longitudinal axis thereof following the longitudinal axis defining a length dimension of the heating body over at least one length between one eighth and half said length of said heating body.

25. The water heater according to claim 1, including a plurality of longitudinal channels which are juxtaposed and in fluid communication with one another, the at least one of the longitudinal channels receiving the at least one inductive module of the induction-heating device.

26. The water heater according to claim 1, wherein the at least one inductive module is arranged centrally relative to a thickness and a width of the heating body.

27. The water heater according to claim 1, in which the at least one inductive module defines a water passage between the at least one inductor and said at least one load, said at least one inductor exposing the water to a magnetic field which prevents deposition of scale of said at least one load.
